(19) United States
(12) Patent Application Publication
(10) Pub. No.: US 2012/0119996 A1
(43) Pub. Date: May 17, 2012

(54) KEY STRUCTURE AND CAPACITIVE SENSING DEVICE USING THE SAME THEREOF

(75) Inventors: Wen-Yen Wu, Taichung City (TW); Chih-Ming Chang, Taoyuan County (TW)

(73) Assignee: QISDA CORPORATION, Taoyuan Shien (TW)

(21) Appl. No.: 13/297,285

(22) Filed: Nov. 16, 2011

(30) Foreign Application Priority Data
Nov. 16, 2010 (TW) 99139439

(51) Int. Cl. G06F 3/02

(52) U.S. Cl. 345/168

(57) ABSTRACT

A key structure and a capacitive sensing device using the same are provided. The key structure is disposed on the capacitive sensing panel. The key structure comprises a pressing portion and a support portion. The pressing portion has a pressing surface and a conductive surface opposite to the pressing surface. The pressing surface is connected to the conductive surface, which faces the capacitive sensing panel. The support portion is connected to the pressing portion. When the pressing portion is pressed, the conductive surface of the pressing portion is close to or touches the capacitive sensing panel.

This application claims the benefit of Taiwan application Serial No. 99139439, filed Nov. 16, 2010, the subject matter of which is incorporated herein by reference.

### BACKGROUND OF THE INVENTION

1. Field of the Invention

The invention relates in general to a key structure and capacitive sensing device using the same, and more particularly to a physical key structure and a capacitive sensing device using the same.

2. Description of the Related Art

Conventional sensing panel, such as touch panel, can sense the touch made by finger or stylus and execute corresponding function accordingly. For example, the touch panel displays a virtual keyboard, and the touch panel will display corresponding numbers or letters or execute corresponding functions when the finger is close to or touches the virtual keyboard displayed on the touch panel.

When the finger is close to or touches the virtual keyboard displayed on the touch panel, the user needs to keep an eye on whether the finger is close to or touches the position targeted by the user. However, such operation will make the user distracted and disturbed.

### SUMMARY OF THE INVENTION

The invention is directed to a key structure and capacitive sensing device using the same. The key structure provides a tactile sensation of pressing, which makes the user tangibly feel that the press-key is pressed.

According to a first aspect of the present invention, a key structure is provided. The key structure is disposed on a capacitive sensing panel. The key structure comprises a pressing portion and a support portion. The pressing portion has a pressing surface and a conductive surface opposite to the pressing surface. The pressing surface is electrically connected to the conductive surface, which faces the capacitive sensing panel. The support portion is connected to the pressing portion. When the pressing portion is pressed, the conductive surface of the pressing portion is close to or touches the capacitive sensing panel.

According to a second aspect of the present invention, a capacitive sensing device is provided. The capacitive sensing device comprises a capacitive sensing panel and a key structure. The key structure is disposed on the capacitive sensing panel. The key structure comprises a pressing portion and a support portion. The pressing portion has a pressing surface and a conductive surface opposite to the pressing surface. The pressing surface is electrically connected to the conductive surface, which faces the capacitive sensing panel. The support portion is connected to the pressing portion. When the pressing portion is pressed, the conductive surface of the pressing portion is close to or touches the capacitive sensing panel.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 shows an upper view of a capacitive sensing panel according to a first embodiment of the invention;

FIG. 2 shows a cross-sectional view along the direction 2-2′ of FIG. 1;

FIG. 3 shows a cross-sectional view of the key structure according to other implementations; and

FIG. 4 shows a cross-sectional view of the key structure according to a second embodiment of the invention.

### DETAILED DESCRIPTION OF THE INVENTION

### First Embodiment

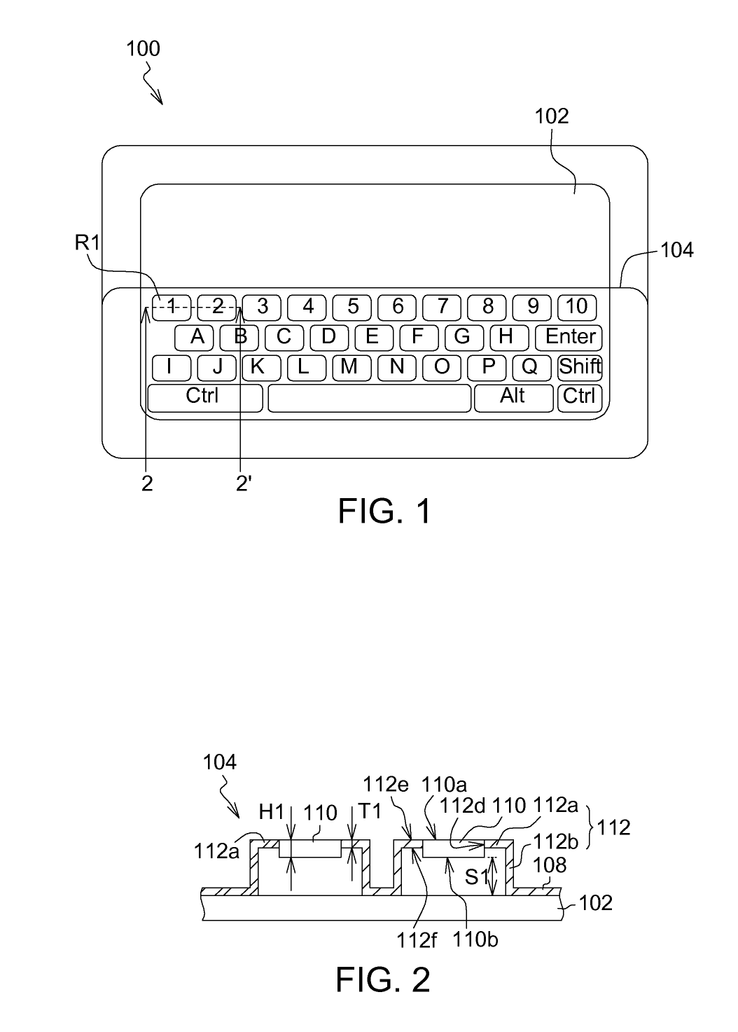

Referring to FIG. 1, an upper view of a capacitive sensing panel according to a first embodiment of the invention is shown.

The capacitive sensing device 100 may be a portable device such as a PDA, notebook computer, tablet computer, cellular phone, a display monitor device, or other similar device.

The capacitive sensing device 100 comprises a capacitive sensing panel 102 and a key structure 104. In one embodiment, the key structure 104 is detachably disposed on the capacitive sensing panel 102. The capacitive sensing panel 102 displays a plurality of press-key patterns. The key structure 104 is disposed on the capacitive sensing panel 102. Examples of the press-key patterns include the numbers and letters illustrated in FIG. 1.

The key structure 104 is an elastic structure. During the process starting from the moment that the user presses the key structure 104 with his/her finger until the key structure 104 is close to or touches a corresponding press-key pattern, the user can feel that the key structure 104 is pressed through the elastic force provided by the key structure 104. Thus, the user does not need keep watching whether the press-key pattern is touched. The structure of the key structure 104 is further elaborated below with detailed descriptions.

Referring to FIG. 2, a cross-sectional view along the direction 2-2′ of FIG. 1 is shown. The key structure 104 comprises a plurality of pressing portions 110, a plurality of support portions 112 and a flexible substrate 108. The support portions 112 is disposed on or connected to the flexible substrate 108. The support portions 112 and the flexible substrate 108 are integrally formed in one piece by the same material in the same manufacturing process. The same material is such as an insulation material, so that before the pressing portion 110 is close to or touches press-key pattern, the key structure 104 and the capacitive sensing panel 102 are still electrically separated.

In an implementation, the flexible substrate 108 has a smooth surface by which the flexible substrate 108 contacts the capacitive sensing panel 102. Through the smooth surface, the flexible substrate 108 and the capacitive sensing panel 102 are more tightly bonded.

The position of the pressing portions 110 correspond to the press-key patterns. Each pressing portion 110 has a pressing surface 110a and a conductive surface 110b opposite to the pressing surface 110a, wherein the pressing surface 110a and the conductive surface 110b are electrically conducted. Since the conductive surface 110b faces the capacitive sensing panel 102, when the pressing portion 110 is pressed, the conductive surface 110b of the pressing portion 110 is close to or touches the capacitive sensing panel 102. When the conductive surface 110b is close to the capacitive sensing panel 102, the capacitance between the conductive surface 110b and the capacitive sensing panel 102 varies, and the capacitive sensing device 100, when detecting the capacitance change, triggers the function corresponding to the press-key pattern.

In addition, the capacitive sensing panel 102 (illustrated in FIG. 1) has an input region R1 corresponding to a function, and the pressing portion 110 is disposed corresponding to the input region R1. When the conductive surface 110b of the pressing portion 110 is close to or touches the capacitive sensing panel 102, the function is performed.

The pressing portion 110 and the conductive surface 110b are conductive and can be formed by materials such as but not limited to conductive block, conductive cloth, conductive graphite or tin-doped indium oxide (ITO). Preferably, the pressing portion 110 is light permeable or formed by a transparent material, so that the press-key pattern displayed on the capacitive sensing panel 102 is viewable through the pressing portion 110, but such exemplification is not for limiting the invention. In an implementation, despite the pressing portion 110 is not permeable to the light, after the pressing portion 110 is pressed, the capacitive sensing panel 102 can display an enlarged frame of the corresponding press-key pattern in other part of the region in which the key structure 104 is displayed for the user to confirm whether the target pressing portion 110 is pressed. Alternatively, in another implementation, the press-key patterns are arranged in a standard form, so that without viewing the key structure 104, the user still can complete the input according to his/her familiarity with the standard arrangement and operation experience. In other implementations, the press-key patterns can be printed on the pressing surface 110a of the pressing portion 110 so that despite the pressing portion 110 is not permeable to the light, the user still can complete input according to the press-key patterns printed on the pressing surface 110a.

The support portion 112 is formed by an elastic material such as rubber. The support portion 112 is a U-shaped structure. For example, the support portion 112 comprises a top portion 112a and a lateral portion 112b, wherein the lateral portion 112b is a ring structure connected to the peripheral of the top portion 112a and forms a U-shaped structure with the top portion 112a. Each pressing portion 110 is disposed on the top portion 112a of the corresponding support portion 11. For example, the pressing portion 110 is fixed in the through hole 112d of the top portion 112a.

In addition, the pressing portion 110 is protruded from the lower surface 112f of the top portion 112a, so that when the key structure 104 is pressed, the conductive surface 110b of the pressing portion 110 is able to touch the capacitive sensing panel 102. For example, the thickness H1 of the pressing portion 110 is larger than the thickness T1 of the top portion 112a, so that the conductive surface 110b of the pressing portion 110 is protruded from the lower surface 112f of the top portion 112a. The pressing surface 110a of the pressing portion 110 is protruded from or aligned with upper surface 112e of the top portion 112a. In the present embodiment of the invention, the pressing surface 110a is aligned with the upper surface 112e.

Due to the thickness H1 of the pressing portion 110, the trigger distance S1 from the conductive surface 110b to the capacitive sensing panel 102 is shortened, and the time for triggering the capacitive sensing panel 102 is reduced. With the shortened trigger distance S1, the user can quickly trigger the capacitive sensing panel 102 by pressing the pressing portion with his/her finger lightly.

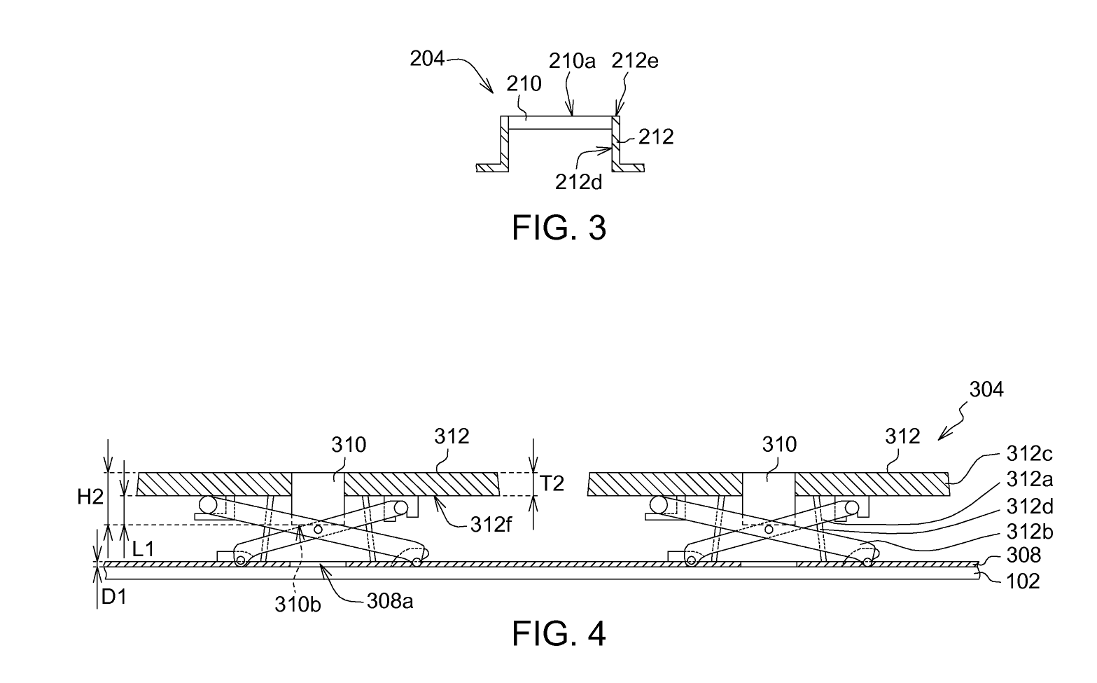

Referring to FIG. 3, a cross-sectional view of the key structure according to other implementations is shown. As indicated in the key structure 204 of FIG. 3, the area of the pressing portion 210 of the key structure 204 is larger than the area of the upper surface 212e of the support portion 212, and the pressing portion 210 with a large area is easier to touch.

Compared to the support portion 112 of FIG. 2, the support portion 212 of the key structure 204 of FIG. 3 omits the top portion 112a of the support portion 112. The pressing portion 210 is connected to the inner lateral surface 212d of the support portion 212 and is close to the upper surface 212e of the support portion 212. Preferred but not restrictively, the pressing surface 210a of the pressing portion 210 and the upper surface 212e of the support portion 212 are basically aligned with each other. Alternatively, the pressing surface 210a and the upper surface 212e are separated by a step distance. For example, the pressing surface 210a is protruded from the upper surface 212e, or the upper surface 212e is protruded from the pressing surface 210a. The step structure provides an obvious tactile sensation, which enables the finger to feel the position of the pressing portion 210 when touching the step structure.

Preferably but not restrictively, the key structure is a one-piece structure. Let the key structure 104 be taken for example. The key structure 104 can be formed by the injection molding technology. Firstly, the pressing portion 110 is placed in the cavity of a mold. Next, a high-temperature liquid material is ejected to encapsulate the peripheral of the pressing portion 110, and the support portion 112 and the flexible substrate 108 will be formed after the liquid material cools down and condenses, and the support portion 112 and the pressing portion 110 are tightly bonded. That is, the pressing portion 110, the support portion 112 and the flexible substrate 108 are formed in the same manufacturing process at the same time.

In the above embodiment, the key structure 104 is exemplified by several sets of corresponding pressing portions and support portions. However, in other implementations, the key structure 104 can comprises only one single pressing portion 110 and one single support portion 112. Under such circumstances, the single support portion 112 can be directly disposed on the capacitive sensing panel 102. Alternatively, the key structure 104 comprises one single pressing portion 110, one single support portion 112 and a flexible substrate (not illustrated) with suitable size, wherein the single support portion 112 is connected to the flexible substrate with suitable size.

### Second Embodiment

Referring to FIG. 4, a cross-sectional view of the key structure according to a second embodiment of the invention is shown. The key structure 304 of the second embodiment is different from the key structure 104 of the first embodiment in that the support portion 312 is an elastic restoring device for restoring the support portion 312 to restore its initial state after the support portion 312 is pressed. Thus, the user can feel the tactile sensation of the key structure 304 being pressed through the elastic force provided by the key structure 304.

The material of the pressing portion 310 is similar to that of the pressing portion 110 of the first embodiment, and the similarities are not repeated here.

The key structure 304 comprises a plurality of pressing portion 310, a plurality of support portions 312 and a flexible substrate 308. The support portion 312 is pivotally disposed on the flexible substrate 308. Each support portion 312 comprises a connecting rod assembly, an elastic member 312d and a top portion. In the present embodiment of the invention, the top portion is realized by a keycap 312c, the connecting rod assembly comprises a first rod 312a and a second rod 312b which are interlaced and pivotally connected. One end of the first rod 312a is pivotally connected the flexible substrate 308, and the other end of the first rod 312a is pivotally connected keycap 312c. One end of the second rod 312b is pivotally connected the flexible substrate 308, and the other end of the second rod 312b is slideably disposed on keycap 312c. In other implementations, the connecting rod assembly can be realized by other shapes.

The elastic member 312d can be realized by a rubber dome, but the invention is not limited to such exemplification. The elastic member 312d connects the lower surface 312f of the keycap 312c to the flexible substrate 308. When the support portion 312 is pressed, the elastic member 312d is deformed and provides an elastic force, through which the user can feel a tactile sensation of the key structure 304 being pressed.

The pressing portion 310 is protruded from the lower surface 312f of the keycap 312c. For example, the thickness H2 of the pressing portion 310 is larger than the thickness T2 of the keycap 312c, so that the conductive surface 310b of the pressing portion 310 can be protruded from the lower surface 312f of the keycap 312c for a protrusion length L1.

The flexible substrate 308 has a substrate through hole 308a, wherein the depth D1 of the substrate through hole 308a is smaller than the protruded length L1, so that after the key structure 304 is pressed, the pressing portion 310 passes through the substrate through hole 308a and touches the capacitive sensing panel 102.

In the key structure 304 of the above embodiment is exemplified by several sets of corresponding pressing portions 310 and support portions 312. However, in other implementations, the key structure 104 can comprises only one single pressing portion 310 and one single support portion 312 and a flexible substrate 308 with suitable size.

The key structure and the capacitive sensing device using the same disclosed in the above embodiments of the invention provide a tactile sensation of pressing, which makes the user really feel that the press-key is pressed.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A key structure disposed on a capacitive sensing panel, wherein the key structure comprises:
a pressing portion having a pressing surface and a conductive surface opposite to the pressing surface, wherein the pressing surface is electrically connected to the conductive surface, and the conductive surface faces the capacitive sensing panel; and
a support portion connected to the pressing portion, wherein the support portion is formed by an insulation material;
wherein, when the pressing portion is pressed, the conductive surface of the pressing portion is close to or touches the capacitive sensing panel.

2. The key structure according to claim 1, wherein the support portion is formed by an elastic material, the support portion has a U-shaped structure, and the pressing portion is disposed on a top portion of the U-shaped structure.

3. The key structure according to claim 2, wherein the pressing portion is protruded from a lower surface of the top portion.

4. The key structure according to claim 1, wherein the support portion has an elastic restoring device for enabling the pressing portion to restore to its initial state after the support portion is pressed.

5. The key structure according to claim 1, wherein the pressing portion is formed by materials comprising conductive cloth, conductive graphite or transparent tin-doped indium oxide (ITO).

6. The key structure according to claim 1, wherein the support portion and the pressing portion are integrally formed in one piece.

7. The key structure according to claim 1, wherein the capacitive sensing panel further displays a plurality of press-key patterns, and the key structure further comprises:
a plurality of pressing portions corresponding to the press-key patterns on the capacitive sensing panel; and
a plurality of support portions detachably disposed on the capacitive sensing panel and each support portion is connected to the corresponding pressing portion.

8. The key structure according to claim 1, wherein the support portion has an upper surface, the pressing surface and the upper surface of the support portion are separated by a step distance.

9. The key structure according to claim 8, wherein the each support portion is formed by an elastic material and is a U-shaped structure, each pressing portion is disposed on a top portion of the corresponding U-shaped structure, and the key structure further comprises:
a flexible substrate disposed on the flexible substrate, wherein the support portions and the flexible substrate are integrally formed in one piece.

10. The key structure according to claim 1, wherein each pressing portion is formed by a transparent material.

11. A capacitive sensing device, comprising:
a capacitive sensing panel; and
a key structure disposed on the capacitive sensing panel, wherein the key structure comprises:
a pressing portion having a pressing surface and a conductive surface opposite to the pressing surface, wherein the pressing surface is electrically connected to the conductive surface, and the conductive surface faces the sensing panel; and
a support portion connected to the pressing portion, wherein the support portion is formed by an insulation material;
wherein, when the pressing portion is pressed, the conductive surface of the pressing portion is close to or touches the capacitive sensing panel.

12. The capacitive sensing device according to claim 11, wherein the support portion is formed by an elastic material, the support portion has a U-shaped structure, and the pressing portion is disposed on a top portion of the U-shaped structure.

13. The capacitive sensing device according to claim 11, wherein the capacitive sensing panel has an input region corresponding to a function, and the pressing portion is disposed corresponding to the input region; when the conductive surface of the pressing portion is close to or touches the capacitive sensing panel, the function is performed.

14. The capacitive sensing device according to claim 11, wherein the support portion has an elastic restoring device for enabling the pressing portion to restore to its initial state after the support portion is pressed.

15. The capacitive sensing device according to claim 11, wherein the pressing portion is formed by materials comprising conductive cloth, conductive graphite or transparent tin-doped indium oxide (ITO).

16. The capacitive sensing device according to claim 11, wherein the support portion and the pressing portion are integrally formed in one piece.

17. The capacitive sensing device according to claim 11, wherein the capacitive sensing panel displays a plurality of press-key patterns, and the key structure further comprises:
a plurality of pressing portions corresponding to the press-key patterns on the capacitive sensing panel; and
a plurality of support portions detachably disposed on the capacitive sensing panel and each support portion is connected to the corresponding pressing portion.

18. The capacitive sensing device according to claim 11, wherein the support portion has an upper surface, the pressing surface and the upper surface of the support portion are separated by a step distance.

19. The capacitive sensing device according to claim 18, wherein the each support portion is formed by an elastic material and is a U-shaped structure, each pressing portion is disposed on a top portion of the corresponding U-shaped structure, and the key structure further comprises:
a flexible substrate disposed on the flexible substrate, wherein the support portions and the flexible substrate are integrally formed in one piece.

20. The capacitive sensing device according to claim 11, wherein each pressing portion is formed by a transparent material.
